(19) United States
(12) Patent Application Publication
(10) Pub. No.: US 2025/0157761 A1
(43) Pub. Date: May 15, 2025

(54) VACUUM INTERRUPTER

(71) Applicant: Mitsubishi Electric Corporation, Chiyoda-ku, Tokyo (JP)

(72) Inventor: Shinichi MIKI, Chiyoda-ku, Tokyo (JP)

(73) Assignee: Mitsubishi Electric Corporation, Chiyoda-ku, Tokyo (JP)

(21) Appl. No.: 18/555,966

(22) PCT Filed: Jan. 24, 2022
(86) PCT No.: PCT/JP2022/002378

§ 371 Date: Oct. 9, 2024

(30) Foreign Application Priority Data
May 31, 2021 (JP) 2021-090796

(51) Int. Cl. H01H 33/664

(52) U.S. Cl. CPC H01H 33/664

(57) ABSTRACT

A fixed side insulation cylinder provided with a fixed side flange on one end side; a movable side insulation cylinder provided with a movable side flange on one end side; a fixed side intermediate flange provided on the other end side of the fixed side insulation cylinder; a movable side intermediate flange provided on the other end side of the movable side insulation cylinder; a fixed side arc shield provided on the fixed side intermediate flange; a movable side arc shield provided on the movable side intermediate flange; a fixed side electric field relaxation shield sandwiched between the fixed side intermediate flange and the fixed side arc shield; and a movable side electric field relaxation shield sandwiched between the movable side intermediate flange and the movable side arc shield.

### TECHNICAL FIELD

The present application relates to a vacuum interrupter.

### BACKGROUND ART

A known vacuum interrupter has a plurality of insulation cylinders made of alumina ceramics or the like; and a fixed side flange and a movable side flange are joined by blazing, respectively, to an end of a fixed side insulation cylinder and an end of a movable side insulation cylinder to be formed into a vacuum vessel.

A fixed conductor and a movable conductor are attached, respectively, to the fixed side flange and the movable side flange. A fixed electrode and a movable electrode which are arranged facing to each other are provided, respectively, on the fixed conductor and the movable conductor. A bellows is joined by blazing between the movable conductor and the movable side flange to enable opening and closing while maintaining a vacuum tight seal.

The bellows is made from thin metal such as stainless steel in a bellows shape. Arc shields are sandwiched between the fixed side insulation cylinder and the movable side insulation cylinder and are fixed by blazing. The arc shields prevent inner surfaces of the insulation cylinders from being adhered by metal vapor generated from the fixed electrode and the movable electrode during current interruption.

### RELATED ART DOCUMENT

### Patent Document

Patent Document 1: JP-A-2003-272492

### SUMMARY OF THE INVENTION

### Problems to be Solved by the Invention

In the above known vacuum interrupter described in Patent Document 1, a problem exists in that when the arc shields are each formed into a shape squeezed inside to prevent the inner surface of the insulation cylinder from being smeared by the metal vapor generated from contacts during current interruption, a metallized layer of an end surface on the intermediate flange side of the insulation cylinder and the arc shield are separated and accordingly an electric field of the metallized layer cannot be relaxed and withstand voltage performance of the inner surface of the insulation cylinder deteriorates.

Furthermore, a problem exists in that when the vacuum interrupter is used by being arranged in pressurized gas, the intermediate flange of the vacuum interrupter is deformed according to gas pressure.

The present application is to disclose a technique for solving the foregoing problem and an object of the present application is to provide a vacuum interrupter with high reliability.

### Means for Solving the Problems

A vacuum interrupter disclosed in the present application is a vacuum interrupter which includes: a fixed side insulation cylinder provided with a fixed side flange on one end side; a movable side insulation cylinder provided with a movable side flange on one end side; a fixed conductor fixed to the fixed side flange and provided with a fixed electrode on a top end portion; a movable conductor provided on the movable side flange and provided with a movable electrode capable of being connected to and separated from the fixed electrode on a top end portion; a fixed side intermediate flange provided on the other end side of the fixed side insulation cylinder; a movable side intermediate flange provided on the other end side of the movable side insulation cylinder; a fixed side arc shield provided on the fixed side intermediate flange; a movable side arc shield provided on the movable side intermediate flange; a fixed side electric field relaxation shield sandwiched between the fixed side intermediate flange and the fixed side arc shield; and a movable side electric field relaxation shield sandwiched between the movable side intermediate flange and the movable side arc shield.

### Advantageous Effect of the Invention

According to the vacuum interrupter disclosed in the present application, the fixed side electric field relaxation shield sandwiched between the fixed side intermediate flange and the fixed side arc shield and the movable side electric field relaxation shield sandwiched between the movable side intermediate flange and the movable side arc shield are provided, whereby withstand voltage performance of an inner wall of the fixed side insulation cylinder and the movable side insulation cylinder can be improved and a vacuum interrupter with high reliability can be obtained.

### BRIEF DESCRIPTION OF THE DRAWINGS

FIG. 1 is a sectional view showing a vacuum interrupter according to Embodiment 1;

FIG. 2 is a sectional view showing a vacuum interrupter according to Embodiment 2; and

FIG. 3 is a sectional view showing a vacuum interrupter according to Embodiment 3.

### MODE FOR CARRYING OUT THE INVENTION

### Embodiment 1

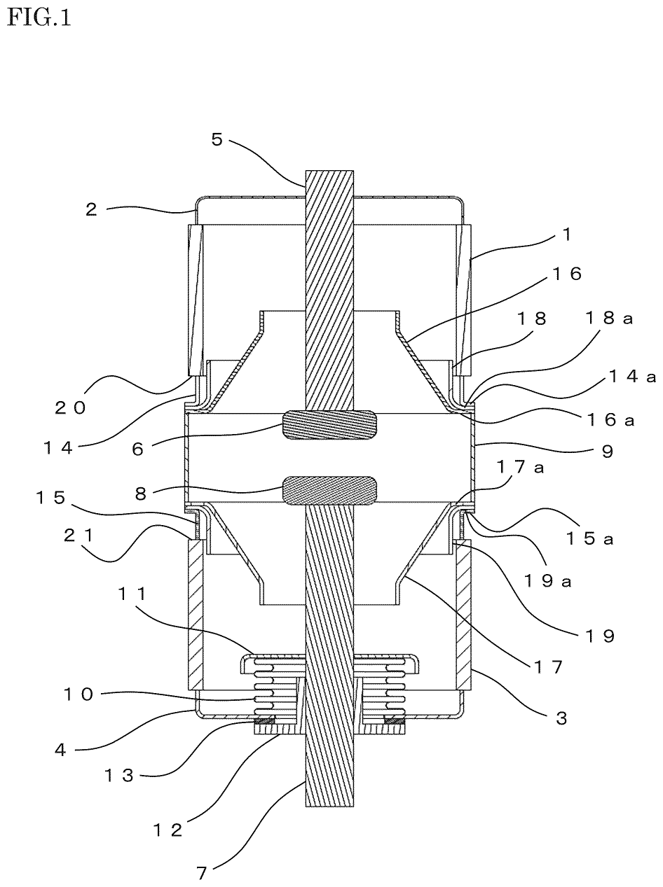

Hereinafter, Embodiment 1 of the present application will be described on the basis of FIG. 1. FIG. 1 is a sectional view showing a vacuum interrupter according to Embodiment 1.

The vacuum interrupter in Embodiment 1 of the present application includes: a fixed side insulation cylinder 1 made of ceramics or the like, provided with a fixed side flange 2 on one end side of the fixed side; a movable side insulation cylinder 3 made of ceramics or the like, provided with a movable side flange 4 on one end side of the movable side; a fixed conductor 5 fixed to the fixed side flange 2 and provided with a fixed electrode 6 on a top end portion; a movable conductor 7 provided on the movable side flange 4 via a bellows 10 and provided with a movable electrode 8 capable of being connected to and separated from the fixed electrode 6 on a top end portion; an intermediate cylinder 9 provided between the other end side of the fixed side insulation cylinder 1 and the other end side of the movable side insulation cylinder 3; a bellows 10 attached to the movable side flange 4; a bellows cover 11 for preventing the bellows 10 from being smeared by metal vapor generated from the fixed electrode 6 and the movable electrode 8 during current interruption; a guide 12 for guiding the movable conductor 7; and a guide mounting plate 13 for fixing the guide 12 to the movable side flange 4.

Then, there are included: a fixed side intermediate flange 14 provided between the other end side of the fixed side insulation cylinder 1 and the intermediate cylinder 9; a movable side intermediate flange 15 provided between the other end side of the movable side insulation cylinder 3 and the intermediate cylinder 9; a fixed side arc shield 16 provided between the fixed side intermediate flange 14 and the intermediate cylinder 9; a movable side arc shield 17 provided between the movable side intermediate flange 15 and the intermediate cylinder 9; a fixed side electric field relaxation shield 18 sandwiched between the fixed side intermediate flange 14 and the fixed side arc shield 16; and a movable side electric field relaxation shield 19 sandwiched between the movable side intermediate flange 15 and the movable side arc shield 17. Furthermore, there is included a metallized layer 20 on an end surface of the other end side of the fixed side insulation cylinder 1; and there is included a metallized layer 21 on an end surface of the other end side of the movable side insulation cylinder 3.

The fixed side intermediate flange 14 is provided with a horizontal portion 14a; the fixed side arc shield 16 is provided with a horizontal portion 16a; the fixed side electric field relaxation shield 18 is provided with a horizontal portion 18a; the horizontal portion 16a of the fixed side arc shield 16 is brought into contact with the intermediate cylinder 9; and the respective horizontal portion 14a, 16a, 18a and the intermediate cylinder 9 are joined by, for example, blazing.

The movable side intermediate flange 15 is provided with a horizontal portion 15a; the movable side arc shield 17 is provided with a horizontal portion 17a; the movable side electric field relaxation shield 19 is provided with a horizontal portion 19a; the horizontal portion 17a of the movable side arc shield 17 is brought into contact with the intermediate cylinder 9; and the respective horizontal portions 15a, 17a, 19a and the intermediate cylinder 9 are joined by, for example, blazing.

The metal vapor is generated from the fixed electrode 6 and the movable electrode 8 during current interruption; and if the metal vapor is adhered to an inner wall of the fixed side insulation cylinder 1 and the movable side insulation cylinder 3, withstand voltage performance of the inner wall of the fixed side insulation cylinder 1 and the movable side insulation cylinder 3 degrades. In order to prevent this, when the inner diameter of the fixed side arc shield 16 and the movable side arc shield 17 is formed into a shape squeezed inside, a gap between the metallized layer 20 on the fixed side intermediate flange 14 side of the fixed side insulation cylinder 1 and the fixed side arc shield 16 increases and a gap between the metallized layer 21 on the movable side intermediate flange 15 side of the movable side insulation cylinder 3 and the movable side arc shield 17 increases.

Accordingly, an electric field of the inside t-ep end of the fixed side metallized layer 20 and the movable side metallized layer 21 becomes high and the withstand voltage performance of the inner wall degrades. In the vacuum interrupter of Embodiment 1 of the present application, the fixed side electric field relaxation shield 18 is joined by blazing between the fixed side intermediate flange 14 and the fixed side arc shield 16; and the movable side electric field relaxation shield 19 is joined by blazing between the movable side intermediate flange 15 and the movable side arc shield 17. The fixed side electric field relaxation shield 18 is arranged close to the fixed side metallized layer 20; and the movable side electric field relaxation shield 19 is arranged close to the movable side metallized layer 21.

Furthermore, in the case of using the vacuum interrupter being arranged in pressurized insulation gas, the horizontal portion 14a of the fixed side intermediate flange 14, the horizontal portion 16a of the fixed side arc shield 16, the horizontal portion 15a of the movable side intermediate flange 15, and the horizontal portion 17a of the movable side arc shield 17 of the vacuum interrupter are deformed according to gas pressure; and if the amount of deformation is large, it does not function as the vacuum interrupter.

In the vacuum interrupter of Embodiment 1 of the present application, the fixed side electric field relaxation shield 18 is joined between the fixed side intermediate flange 14 and the fixed side arc shield 16; the movable side electric field relaxation shield 19 is joined between the movable side intermediate flange 15 and the movable side arc shield 17; the fixed side electric field relaxation shield 18 is made close to the fixed side metallized layer 20; and the movable side electric field relaxation shield 19 is made close to the movable side metallized layer 21. Therefore, the electric field of the inside top end of the fixed side metallized layer 20 and the movable side metallized layer 21 can be reduced; and the withstand voltage performance of the inner wall of the fixed side insulation cylinder 1 and the movable side insulation cylinder 3 can be improved.

Furthermore, the horizontal portion 18a of the fixed side electric field relaxation shield 18 and the horizontal portion 16a of the fixed side arc shield 16 serve as reinforcement of the horizontal portion 14a of the fixed side intermediate flange 14 and the horizontal portion 16a of the fixed side arc shield 16, and the horizontal portion 19a of the movable side electric field relaxation shield 19 and the horizontal portion 17a of the movable side arc shield 17 serve as reinforcement of the horizontal portion 15a of the movable side intermediate flange 15 and the horizontal portion 17a of the movable side arc shield 17; therefore, even if the vacuum interrupter is arranged in pressurized gas, it does not cause adverse deformation that is such as to affect performance of the vacuum interrupter to the horizontal portion 14a of the fixed side intermediate flange 14, the horizontal portion 16a of the fixed side arc shield 16, the horizontal portion 15a of the movable side intermediate flange 15, and the horizontal portion 17a of the movable side arc shield 17 and mechanical strength is improved.

The fixed side electric field relaxation shield 18 is arranged between the fixed side intermediate flange 14 and the fixed side arc shield 16 and is made close to the metallized layer 20 on the end surface of the fixed side insulation cylinder 1; and the movable side electric field relaxation shield 19 is arranged between the movable side intermediate flange 15 and the movable side arc shield 17 and is made close to the metallized layer 21 on the end surface of the movable side insulation cylinder 3; therefore, the electric field of the fixed side metallized layer 20 can be relaxed and the electric field of the movable side metallized layer 21 can be relaxed and thus the withstand voltage performance of the inner wall of the insulation cylinders can be improved.

Furthermore, the fixed side electric field relaxation shield 18 is arranged between the fixed side intermediate flange 14 and the fixed side arc shield 16; and the movable side electric field relaxation shield 19 is arranged between the movable side intermediate flange 15 and the movable side arc shield 17; therefore, mechanical strength is improved with respect to an axial direction of the vacuum interrupter of the fixed side intermediate flange 14 and the movable side intermediate flange 15.

The description has been made on the case where the horizontal portion 14a of the fixed side intermediate flange 14, the horizontal portion 16a of the fixed side arc shield 16, the horizontal portion 18a of the fixed side electric field relaxation shield 18, and the intermediate cylinder 9 are joined by blazing; and the horizontal portion 15a of the movable side intermediate flange 15, the horizontal portion 17a of the movable side arc shield 17, the horizontal portion 19a of the movable side electric field relaxation shield 19, and the intermediate cylinder 9 are joined by blazing; however, the present application is not limited to this and it goes without saying that similar effects can be obtained even by welding.

### Embodiment 2

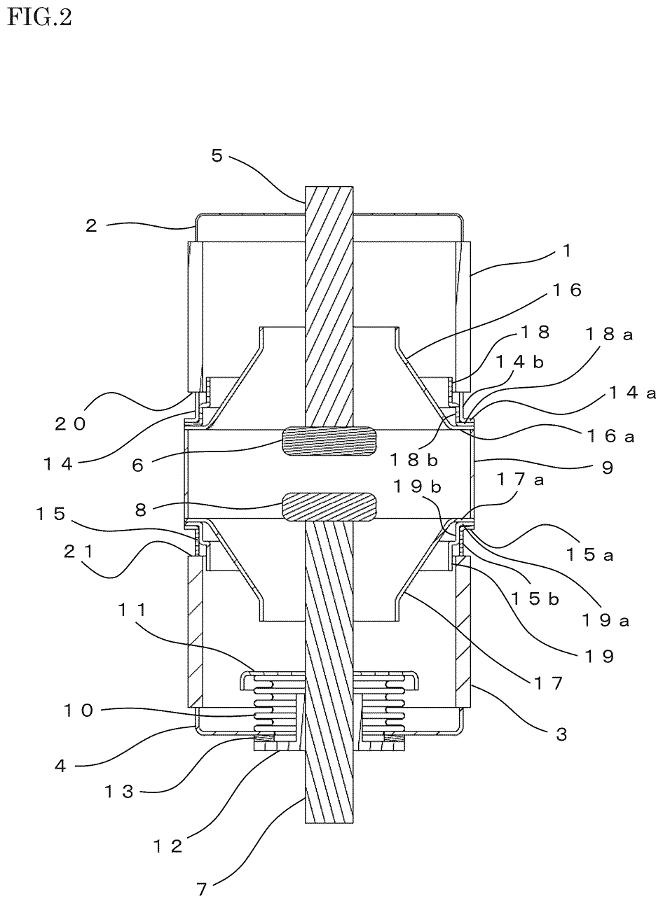

Embodiment 2 of the present application will be described on the basis of FIG. 2. FIG. 2 is a sectional view showing a vacuum interrupter according to Embodiment 2. Embodiment 2 of the present application differs from only the configuration of a fixed side electric field relaxation shield 18 and a movable side electric field relaxation shield 19, compared to the structure of the vacuum interrupter presented in the above Embodiment 1.

A vertical portion 18b parallel to an axial direction of the vacuum interrupter which is bent from a horizontal portion 18a of the fixed side electric field relaxation shield 18 is brought into contact with a part of a side surface of a fixed side intermediate flange 14, that is, a vertical portion 14b; and a vertical portion 19b parallel to the axial direction of the vacuum interrupter which is bent from a horizontal portion 19a of the movable side electric field relaxation shield 19 is brought into contact with a part of a side surface of a movable side intermediate flange 15, that is, a vertical portion 15b.

In the case of using the vacuum interrupter being arranged in pressurized insulation gas, the vertical portion 14b of the fixed side intermediate flange 14 and the vertical portion 15b of the movable side intermediate flange 15 of the vacuum interrupter are deformed according to gas pressure; and if the amount of deformation is large, it does not function as the vacuum interrupter.

In the vacuum interrupter of Embodiment 2 of the present application, the fixed side electric field relaxation shield 18 is joined between the fixed side intermediate flange 14 and a fixed side arc shield 16; the movable side electric field relaxation shield 19 is joined between the movable side intermediate flange 15 and a movable side arc shield 17; the fixed side electric field relaxation shield 18 is made close to a fixed side metallized layer 20; and the movable side electric field relaxation shield 19 is made close to a movable side metallized layer 21.

Therefore, an electric field of the inside top end of the fixed side metallized layer 20 and the movable side metallized layer 21 can be reduced; and withstand voltage performance of an inner wall of a fixed side insulation cylinder 1 and a movable side insulation cylinder 3 can be improved.

Furthermore, the horizontal portion 18a of the fixed side electric field relaxation shield 18 and a horizontal portion 16a of the fixed side arc shield 16 serve as reinforcement of a horizontal portion 14a of the fixed side intermediate flange 14 and the horizontal portion 16a of the fixed side arc shield 16, and the horizontal portion 19a of the movable side electric field relaxation shield 19 and a horizontal portion 17a of the movable side arc shield 17 serve as reinforcement of a horizontal portion 15a of the movable side intermediate flange 15 and the horizontal portion 17a of the movable side arc shield 17; therefore, even if the vacuum interrupter is arranged in pressurized gas, it does not cause adverse deformation that is such as to affect performance of the vacuum interrupter to the horizontal portion 14a of the fixed side intermediate flange 14, the horizontal portion 16a of the fixed side arc shield 16, the horizontal portion 15a of the movable side intermediate flange 15, and the horizontal portion 17a of the movable side arc shield 17 and mechanical strength is improved.

Further, the vertical portion 18b that comes into contact with the vertical portion 14b of the fixed side intermediate flange 14 is provided on the fixed side electric field relaxation shield 18 and the vertical portion 19b that comes into contact with the vertical portion 15b of the movable side intermediate flange 15 is provided on the movable side electric field relaxation shield 19; therefore, the fixed side intermediate flange 14 and the movable side intermediate flange 15 do not cause adverse deformation in a radial direction which is such as to affect performance of the vacuum interrupter and mechanical strength is improved.

Furthermore, the description has been made on the case where the vertical portion 18b of the fixed side electric field relaxation shield 18 is brought into contact with the vertical portion 14b of the fixed side intermediate flange 14 and the vertical portion 19b of the movable side electric field relaxation shield 19 is brought into contact with the vertical portion 15b of the movable side intermediate flange 15; however, it is also possible to be joined by blazing or welding.

### Embodiment 3

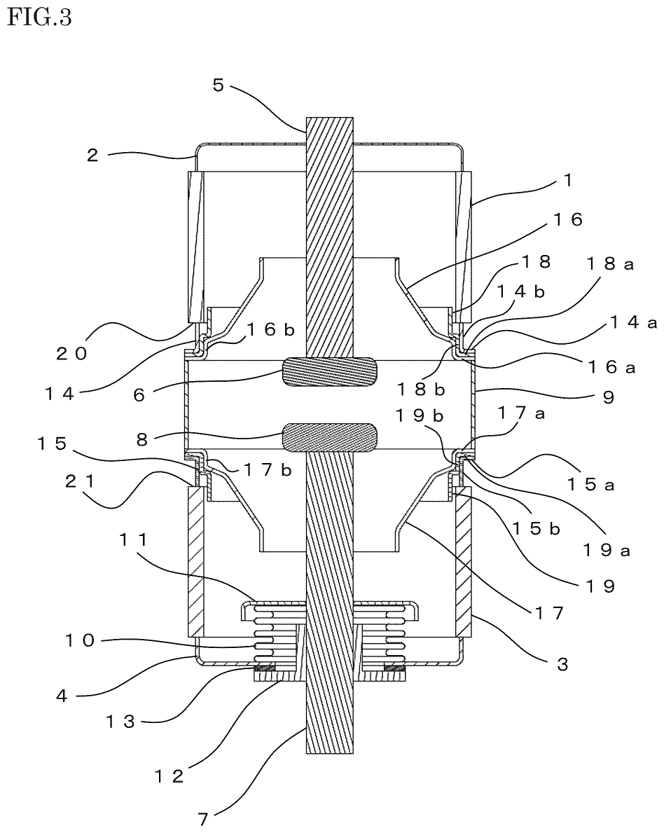

Embodiment 3 of the present application will be described on the basis of FIG. 3. FIG. 3 is a sectional view showing a vacuum interrupter according to Embodiment 3. Embodiment 3 of the present application differs from only the configuration of a fixed side arc shield 16 and a movable side arc shield 17, compared to the structure of the vacuum interrupter presented in the above Embodiment 1.

A vertical portion 18b parallel to an axial direction of the vacuum interrupter which is bent from a horizontal portion 18a of a fixed side electric field relaxation shield 18 is brought into contact with a part of a side surface of a fixed side intermediate flange 14, that is, a vertical portion 14b; a vertical portion 19b parallel to the axial direction of the vacuum interrupter which is bent from a horizontal portion 19a of the movable side electric field relaxation shield 19 is brought into contact with a part of a side surface of a movable side intermediate flange 15, that is, a vertical portion 15b; the fixed side arc shield 16 is brought into contact with a part of a side surface of the fixed side electric field relaxation shield 18, that is, the vertical portion 18b; and the movable side arc shield 17 is brought into contact with a part of a side surface of the movable side electric field relaxation shield 19, that is, the vertical portion 19b.

In the case of using the vacuum interrupter being arranged in pressurized insulation gas, the vertical portion 14b of the fixed side intermediate flange 14 and the vertical portion 15b of the movable side intermediate flange 15 of the vacuum interrupter are deformed according to gas pressure; and if the amount of deformation is large, it does not function as the vacuum interrupter.

In the vacuum interrupter of Embodiment 3 of the present application, the fixed side electric field relaxation shield 18 is joined between the fixed side intermediate flange 14 and the fixed side arc shield 16; the movable side electric field relaxation shield 19 is joined between the movable side intermediate flange 15 and the movable side arc shield 17; the fixed side electric field relaxation shield 18 is made close to a fixed side metallized layer 20; and the movable side electric field relaxation shield 19 is made close to a movable side metallized layer 21.

Therefore, an electric field of the inside top end of the fixed side metallized layer 20 and the movable side metallized layer 21 can be reduced; and withstand voltage performance of an inner wall of a fixed side insulation cylinder 1 and a movable side insulation cylinder 3 can be improved.

Furthermore, the horizontal portion 18a of the fixed side electric field relaxation shield 18 and a horizontal portion 16a of the fixed side arc shield 16 serve as reinforcement of a horizontal portion 14a of the fixed side intermediate flange 14 and the horizontal portion 16a of the fixed side arc shield 16, and the horizontal portion 19a of the movable side electric field relaxation shield 19 and a horizontal portion 17a of the movable side arc shield 17 serve as reinforcement of a horizontal portion 15a of the movable side intermediate flange 15 and the horizontal portion 17a of the movable side arc shield 17; therefore, even if the vacuum interrupter is arranged in pressurized gas, it does not cause adverse deformation that is such as to affect performance of the vacuum interrupter to the horizontal portion 14a of the fixed side intermediate flange 14, the horizontal portion 16a of the fixed side arc shield 16, the horizontal portion 15a of the movable side intermediate flange 15, and the horizontal portion 17a of the movable side arc shield 17 and mechanical strength is improved.

Further, the vertical portion 18b that comes into contact with the vertical portion 14b of the fixed side intermediate flange 14 is provided on the fixed side electric field relaxation shield 18, the vertical portion 19b that comes into contact with the vertical portion 15b of the movable side intermediate flange 15 is provided on the movable side electric field relaxation shield 19, a vertical portion 16b that comes into contact with the vertical portion 18b of the fixed side electric field relaxation shield 18 is provided on the fixed side arc shield 16, and the vertical portion 17b that comes into contact with the vertical portion 19b of the movable side electric field relaxation shield 19 is provided on the movable side arc shield 17; therefore, the fixed side intermediate flange 14 and the movable side intermediate flange 15 do not cause adverse deformation in a radial direction which is such as to affect performance of the vacuum interrupter and mechanical strength is further improved than the above Embodiment 2.

Furthermore, the description has been made on the case where the vertical portion 18b of the fixed side electric field relaxation shield 18 is brought into contact with the vertical portion 14b of the fixed side intermediate flange 14, the vertical portion 19b of the movable side electric field relaxation shield 19 is brought into contact with the vertical portion 15b of the movable side intermediate flange 15, the vertical portion 16b of the fixed side arc shield 16 is brought into contact with the vertical portion 18b of the fixed side electric field relaxation shield 18, and the vertical portion 17b of the movable side arc shield 17 is brought into contact with the vertical portion 19b of the movable side electric field relaxation shield 19; however, it is also possible to be joined by blazing or welding.

The present application describes various exemplified embodiments and examples; however, various features, aspects, and functions described in one or a plurality of embodiments are not limited to specific embodiments, but are applicable to embodiments individually or in various combinations thereof. Therefore, countless modified examples not exemplified are assumed in technical ranges disclosed in the specification of the present application. For example, there include: a case in which at least one constitutional element is modified; a case, added; or a case, omitted; and a case in which at least one constitutional element is extracted to combine with constitutional elements of other embodiments.

### INDUSTRIAL APPLICABILITY

The present application is suitable for actualizing a vacuum interrupter with high reliability.

### DESCRIPTION OF REFERENCE NUMERALS

1 Fixed side insulation cylinder, 2 Fixed side flange, 3 Movable side insulation cylinder, 4 Movable side flange, 5 Fixed conductor, 6 Fixed electrode, 7 Movable conductor, 8 Movable electrode, 9 Intermediate cylinder, 14 Fixed side intermediate flange, 14a Horizontal portion, 14b Vertical portion, 15 Movable side intermediate flange, 15a Horizontal portion, 15b Vertical portion, 16 Fixed side arc shield, 16a Horizontal portion, 16b Vertical portion, 17 Movable side arc shield, 17a Horizontal portion, 17b Vertical portion, 18 Fixed side electric field relaxation shield, 18a Horizontal portion, 18b Vertical portion, 19 Movable side electric field relaxation shield, 19a Horizontal portion, 19b Vertical portion

1. A vacuum interrupter comprising:
a fixed side insulation cylinder provided with a fixed side flange on one end side;
a movable side insulation cylinder provided with a movable side flange on one end side;
a fixed conductor fixed to the fixed side flange and provided with a fixed electrode on a top end portion;
a movable conductor provided on the movable side flange and provided with a movable electrode capable of being connected to and separated from the fixed electrode on a top end portion;
a fixed side intermediate flange provided on the other end side of the fixed side insulation cylinder and having a horizontal portion extended in a horizontal direction
a movable side intermediate flange provided on the other end side of the movable side insulation cylinder and having a horizontal portion extended in a horizontal direction
a fixed side arc shield provided being brought into contact with the horizontal portion of the fixed side intermediate flange and having a horizontal portion extended in the horizontal direction;
a movable side arc shield provided being brought into contact with the horizontal portion of the movable side intermediate flange and having a horizontal portion extended in the horizontal direction;
a fixed side electric field relaxation shield which is arranged between the fixed side intermediate flange and the fixed side arc shield and in which a horizontal portion extended in the horizontal direction is sandwiched between the horizontal portion of the fixed side intermediate flange and the horizontal portion of the fixed side arc shield; and
a movable side electric field relaxation shield which is arranged between the movable side intermediate flange and the movable side arc shield and in which a horizontal portioned extended in the horizontal direction is sandwiched between the horizontal portion of the movable side intermediate flange and the horizontal portion of the movable side arc shield.

2. (canceled)

3. The vacuum interrupter according to claim 1,
wherein the fixed side electric field relaxation shield is brought into contact with a part of a side surface of the fixed side intermediate flange; and
the movable side electric field relaxation shield is brought into contact with a part of a side surface of the movable side intermediate flange.

4. The vacuum interrupter according to claim 3,
wherein the fixed side arc shield is brought into contact with a part of a side surface of the fixed side electric field relaxation shield; and
the movable side arc shield is brought into contact with a part of a side surface of the movable side electric field relaxation shield.

5. The vacuum interrupter according to claim 1,
wherein the fixed side intermediate flange, the fixed side arc shield, and the fixed side electric field relaxation shield are joined by blazing or joined by welding; and
the movable side intermediate flange, the movable side arc shield, and the movable side electric field relaxation shield are joined by blazing or joined by welding.

6. The vacuum interrupter according to claim 1,
wherein an intermediate cylinder is provided between the fixed side arc shield and the movable side arc shield.

7. The vacuum interrupter according to claim 6,
wherein the fixed side intermediate flange, the fixed side arc shield, and the fixed side electric field relaxation shield are joined by blazing or joined by welding; and
the movable side intermediate flange, the movable side arc shield, and the movable side electric field relaxation shield are joined by blazing or joined by welding.

8. The vacuum interrupter according to claim 3,
wherein the fixed side intermediate flange, the fixed side arc shield, and the fixed side electric field relaxation shield are joined by blazing or joined by welding; and
the movable side intermediate flange, the movable side arc shield, and the movable side electric field relaxation shield are joined by blazing or joined by welding.

9. The vacuum interrupter according to claim 4,
wherein the fixed side intermediate flange, the fixed side arc shield, and the fixed side electric field relaxation shield are joined by blazing or joined by welding; and
the movable side intermediate flange, the movable side arc shield, and the movable side electric field relaxation shield are joined by blazing or joined by welding.

10. The vacuum interrupter according to claim 3,
wherein an intermediate cylinder is provided between the fixed side arc shield and the movable side arc shield.

11. The vacuum interrupter according to claim 4,
wherein an intermediate cylinder is provided between the fixed side arc shield and the movable side arc shield.

12. The vacuum interrupter according to claim 10,
wherein the fixed side intermediate flange, the fixed side arc shield, and the fixed side electric field relaxation shield are joined by blazing or joined by welding; and
the movable side intermediate flange, the movable side arc shield, and the movable side electric field relaxation shield are joined by blazing or joined by welding.

13. The vacuum interrupter according to claim 11,
wherein the fixed side intermediate flange, the fixed side arc shield, and the fixed side electric field relaxation shield are joined by blazing or joined by welding; and
the movable side intermediate flange, the movable side arc shield, and the movable side electric field relaxation shield are joined by blazing or joined by welding.
